(19) United States
(12) Patent Application Publication
(10) Pub. No.: US 2007/0124284 A1
(43) Pub. Date: May 31, 2007

(54) Systems, methods and media for searching a collection of data, based on information derived from the data

(76) Inventors: Jessica F. Lin, Austin, TX (US); Nadeem Malik, Austin, TX (US); Steven L. Roberts, Cedar Park, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/289,094

(22) Filed: Nov. 29, 2005

(51) Int. Cl. G06F 17/30

(52) U.S. Cl. 707/3

(57) ABSTRACT

Systems, methods and media for content-based search processing are disclosed. In one embodiment, a database is organized according to keywords. Data corresponding to keywords is searched to produce search results within the context of the keywords input by a user. The search results are analyzed to determine features of the data. A feature may be determined by identifying data with common traits. Data is then organized into categories according to the traits. The search results produce information and features of the data that a user may not have thought of but would find useful.

### FIELD

The present invention is in the field of computer communications and data searches. More particularly, the invention relates to searching a collection of data based on information derived from the data.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, and accounting. Further, networks enable high speed communication between people in diverse locations by way of e-mail, websites, instant messaging, and web-conferencing.

At the heart of each computer and server in a network is a microprocessor capable of executing computer instructions. These instructions are executed in execution units adapted to execute specific instructions. In a superscalar architecture, these execution units typically comprise load/store units, integer Arithmetic/Logic Units, floating point Arithmetic/Logic Units, and Graphical Logic Units that operate in parallel. In a processor architecture, an operating system controls operation of the processor and components peripheral to the processor. Executable application programs are stored in a computer's hard drive. The computer's processor causes application programs to run in response to user inputs.

Today, millions communicate and exchange information by way of computers connected to the Internet. Through the Internet, websites enable a user to access Website pages posted by other users, institutions, manufacturing companies, service providers, news media, etc. Search engines, such as those provided by Yahoo and Google, enable a user to search out information covering any topic under the sun by use of keywords. For example, a user may want to search restaurants in Austin, Texas. First, the user will launch a web browser program such as Internet Explorer or Netscape. A home web page will appear on the screen of the user's video display. The home web page may be provided by the Internet Service Provider (ISP) that the user employs. Usually, the home web page will provide a window to enter key words to conduct a search. In the present example, a user may enter the keywords, “restaurant” and “Austin”. A search engine will read the key words entered by the user. The search engine will produce a list of website links that contain the keywords or that are classified under the keywords. The searcher may click on the link in the list to go to that website.

Typically, a search engine service provider will categorize websites in advance of a search request. For example, the search engine service provider will derive a list of websites that are hosted by restaurants. The sites may be further differentiated with respect to location. The search engine service would then display on the user's video monitor a list of links to the web pages that fall into the categories “restaurant” and “Austin”, in response to a keyword search of the keywords “restaurant” and “Austin”.

Searchable website content has increased dramatically over the years and continues to increase. Consequently, simple keyword searches may produce a large multitude of links relevant in some way to the keywords. For example, the search of restaurants in Austin may produce over 300 links. Some of these links are to websites posted by restaurants and some of these links may be to newspaper articles about restaurants in Austin. The user is confronted with too much information to quickly come to a decision about what restaurant to choose. The problem is that the user does not know what is the best kind of food in Austin and which restaurants have the best atmosphere, etc. The user may have to read lots of material from many links before finding out where to go.

Techniques have been developed to enhance search results based on prior history. For example, suppose one searches Amazon.com for an engineering textbook covering wireless technology. One may enter the keywords “engineering” and “wireless”. This may produce over 700 links to books relating to engineering, wireless technology. One may select to review a particular book in the list by clicking on the link for the particular book. A web page appears featuring the book, including a brief description, a link to a table of contents, and information about the author. The web page will also display links to web pages featuring books that have been bought by the people who have bought the particular book selected for review. Further, the Amazon search service will provide links to books that are similar to books one has bought in the past.

Other examples of using prior history to enhance present search results are known. These techniques derive search results based on derivatives of the input queries of the users. They are deficient because they do not use inherent trends in the searchable content to expand the utility of the search. What is needed therefore is a search process that overcomes deficiencies of the prior art.

### SUMMARY

The problems identified above are in large part addressed by systems, methods and media for content-based searches as disclosed herein. One embodiment is a search processor to process searches of data content of a database. The embodiment comprises a search engine to search data content of the database, the content identified according to keywords input by a user. The embodiment also comprises a content analyzer to analyze the data content resulting from a search and to determine a feature of the data. The search engine may comprise a natural language search mechanism to determine words characterizing content of the data. The content analyzer may then analyze the words determined by the natural language search mechanism to determine a feature of the data. The content analyzer may further comprise a cluster analyzer to determine data clusters. Thus, more generally, the content analyzer may be adapted to determine a feature of the data by identifying data with a similar trait. Further, the search processor may comprise a link organizer to organize links to data according to categories determined by the content analyzer.

Embodiments include a web search mechanism, comprising a database accessible by a server, the database comprising links to web pages categorized according to keywords. The server comprises a search engine to search database content according to keywords input by a user. The server also comprises a content analyzer to analyze the data content of the search results to determine a feature of the data. The content analyzer may be adapted to determine a feature of the data by identifying data with a similar trait. This may be done by performing a cluster analysis of the data. The search engine may be adapted to perform a natural language search upon the data to determine words characterizing the data. The web search mechanism may further comprise a link organizer to organize links to web pages according to categories determined by the content analyzer.

Another embodiment of the invention provides a machine-accessible medium containing instructions effective, when executing in a data processing system, to cause the system to perform a series of operations for processing searches of data base contents. The instructions, when executed by the machine, cause the machine to perform operations, comprising determining a collection of data in the database according to keywords, performing a search upon the data in the collection to produce search result data, and analyzing the search result data to determine a feature of the search result data. The operations may further comprise performing a natural language search upon the data to determine words characterizing the data. The operations may further comprise determining a feature of the search result data by identifying data that exhibit a common trait. Also, the operations may comprise organizing data of the search result data according to categories determined by analyzing the search result data.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a server within a network; within the server is a processor.

FIG. 2A depicts a block diagram of an embodiment for content-based search processing.

FIG. 2 depicts an embodiment of a processor within a server or computer that may be configured to perform content-based search processing.

FIG. 3 depicts a flowchart of an embodiment for performing a content-based search of information and reporting the results to a user.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for content-based search processing are disclosed. In one embodiment, a database is organized according to keywords. Data corresponding to keywords is searched to produce search results within the context of the keywords input by a user. The search results are analyzed to determine features of the data. A feature may be determined by identifying data with common traits. Data is then organized into categories according to the traits. The search results produce information and features of the data that a user may not have thought of but would find useful.

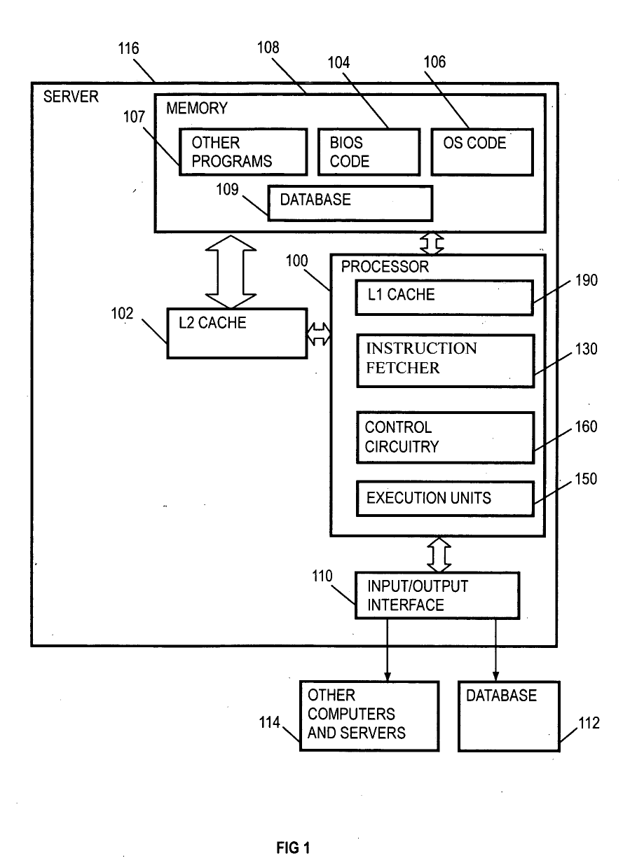

FIG. 1 shows a server 116 implemented according to one embodiment of the present invention. Server 116 comprises a processor 100 that can operate according to BIOS (Basis Input/Output System) Code 104 and Operating System (OS) Code 106. The BIOS and OS code is stored in memory 108. The BIOS code is typically stored on Read-Only Memory (ROM) and the OS code is typically stored on the hard drive of system 116. Server 116 comprises a level 2 (L2) cache 102 located physically close to processor 100. Memory 108 also stores other programs for execution by processor 100 and stores data in a database 109 or other data storage format. In an embodiment, memory 108 stores computer code to perform content-based searching and data analysis, as will be described herein.

Processor 100 comprises an on-chip level one (L1) cache 190, an instruction fetcher 130, control circuitry 160, and execution units 150. Level 1 cache 190 receives and stores instructions that are near to time of execution. Instruction fetcher 130 fetches instructions from memory. Execution units 150 perform the operations called for by the instructions. Execution units 150 may comprise load/store units, integer Arithmetic/Logic Units, floating point Arithmetic/Logic Units, and Graphical Logic Units. Each execution unit comprises stages to perform steps in the execution of the instructions fetched by instruction fetcher 130. Control circuitry 160 controls instruction fetcher 130 and execution units 150. Control circuitry 160 also receives information relevant to control decisions from execution units 150. For example, control circuitry 160 is notified in the event of a data cache miss in the execution pipeline to process a stall.

Server 116 also typically includes other components and subsystems not shown, such as: a Trusted Platform Module, memory controllers, random access memory (RAM), peripheral drivers, a system monitor, a keyboard, a color video monitor, one or more flexible diskette drives, one or more removable non-volatile media drives such as a fixed disk hard drive, CD and DVD drives, a pointing device such as a mouse, and a network interface adapter, etc. Server 116 may connect personal computers, workstations, servers, mainframe computers, notebook or laptop computers, desktop computers, or the like. Thus, processor 100 may also communicate with other servers and computers 114 by way of Input/Output Device 110. Thus, server 116 may be in a network of computers such as the Internet and/or a local intranet. Further, server 116 may access a database 112 and other memory comprising tape drive storage, hard disk arrays, RAM, ROM, etc.

Thus, in one mode of operation of server 116, the L2 cache 102 receives from memory 108 data and instructions expected to be processed in the processor pipeline of processor 100. L2 cache 102 is fast memory located physically close to processor 100 to achieve greater speed. The L2 cache receives from memory 108 the instructions for a plurality of instruction threads. Such instructions may include load and store instructions, branch instructions, arithmetic logic instructions, floating point instructions, etc. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Execution units 150 may comprise load/store units, integer Arithmetic/Logic Units, floating point Arithmetic/Logic Units, and Graphical Logic Units. Each of the units may be adapted to execute a specific set of instructions. Instructions can be submitted to different execution units for execution in parallel. In one embodiment, two execution units are employed simultaneously to execute certain instructions. Data processed by execution units 150 are storable in and accessible from integer register files and floating point register files (not shown.) Data stored in these register files can also come from or be transferred to on-board L1 cache 190 or an external cache or memory. The processor can load data from memory, such as L1 cache, to a register of the processor by executing a load instruction. The processor can store data into memory from a register by executing a store instruction.

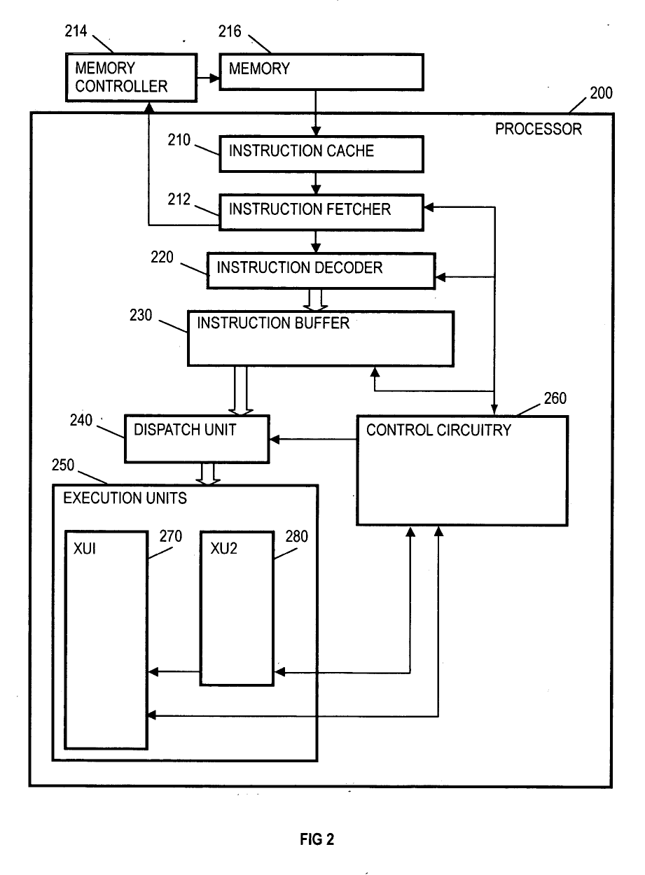

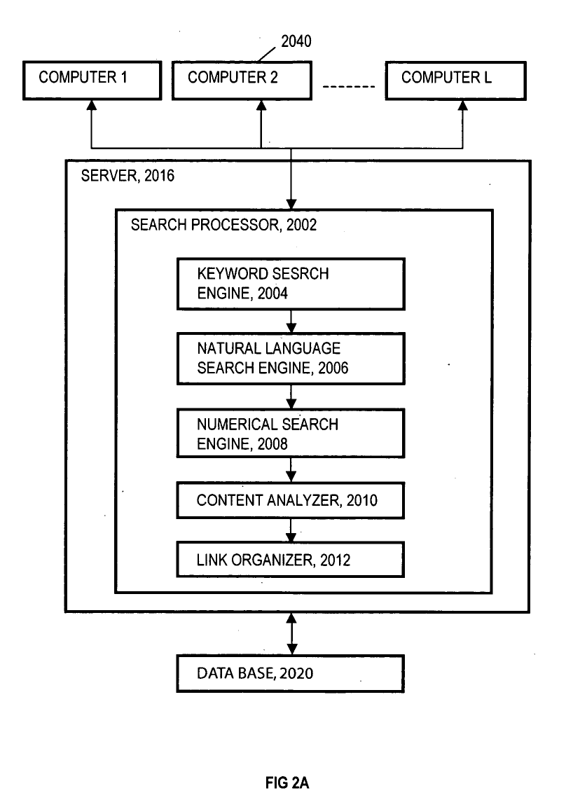

The processor of FIG. 1 within server 116 can execute software to perform content-based search processing. FIG. 2A shows a functional block diagram of a processor configured within a server 2016 as a search processor 2002. Server 2016 facilitates and coordinates communications between the computers 2040 in a network. Each computer 2040 has its own memory for storing its operating system, BIOS, and the code for executing application programs, as well as files and data. The memory of a computer comprises Read-Only-Memory (ROM), cache memory implemented in DRAM and SRAM, a hard disk drive, CD drives and DVD drives. Server 2016 also has its own memory and may control access to other memory such as tape drives and hard disk arrays. Each computer 2040 may store and execute its own application programs. Some application programs, such as database application programs, may reside in the server. Thus, each computer may access the same database 2020 stored at the server location. In addition, each computer may access other memory by way of the server 2016.

Search processor 2002 comprises a keyword search engine 2004 to conduct keyword searches of the content of web pages or a database. This may be done in advance. For example, when a user inputs the keywords “restaurant” and “Austin” into the search engine, search results may be displayed that were previously compiled for the category containing Austin restaurants. Thus, data in a database may be organized into categories based on keywords. Search processor 2002 further comprises a natural language search engine 2006 to conduct natural language searches. Natural language search engine 2006 searches the content of web pages that were found as a result of a keyword search by keyword search engine 2004. Natural language search engine 2006 identifies words within the keyword search results that characterize the data of the search results. For example, suppose a keyword search for Austin restaurants is performed to produce links to web pages. The natural language search engine 2006 will analyze the content of the web pages to determine information in categories that may be useful to the user. For example, natural language search engine 2006 may determine what cuisine is offered at a restaurant by analyzing the content of its web page. Natural language search engine 2006 may also determine that live music is offered at a restaurant.

Search processor 2002 further comprises a numerical search engine 2008. Numerical search engine 2008 performs searches on numerical data contained at web pages produced by keyword search engine 2004. For example, numerical search engine 2008 may perform a numerical search of web pages resulting from a search of automobiles to determine a set of vehicles within a mileage range.

A content analyzer 2010 analyzes the results of natural language search engine 2006 and numerical search engine 2008 to determine trends or features of the content of the web pages that were searched. Content analyzer 2010 may determine a feature of the data by identifying data with a common trait. For example, content analyzer 2010 will determine from the results of the search for cuisine offered by Austin restaurants, that certain types of cuisine, such as barbecue, are listed with high frequency. Therefore, content analyzer 2010 will determine a category identifying BBQ as a feature of the searched data. As another example, content analyzer 2010 may determine from the results of a numerical search, that a cluster of vehicles in a vehicle search of automobile web pages have around 50,000 miles.

The algorithm that content analyzer 2010 employs may be one of several different algorithms that one may select. Thus, a user may not only provide keywords, but also select from a list of search algorithms. In one embodiment, content analyzer 2010 comprises a data clustering algorithm to perform a clustering analysis of the data. Data clustering is a common technique for statistical data analysis and is used in many fields, including machine learning, pattern recognition, and image analysis. Clustering is the classification of similar objects into groups, or more precisely, the partitioning of a data set into subsets (clusters), so that the data in each subset share some common trait—often proximity according to some defined distance measure. In one method of clustering, the data is clustered heirarchically. In another method of clustering, data is clustered around centroids of the data. Other clustering techniques are described in the art. Generally, a cluster may be described as a collection of data objects that are similar in some sense and can thus be treated collectively as one group. A good clustering method is one that produces objects in a cluster that have high similarity and excludes objects from the cluster that do not share that similarity. Content analyzer 2010 may therefore determine features of the data by clustering analysis.

Suppose that a user conducts a keyword search for a BMW, model year 2002 with 36 thousand miles. Keyword search engine 2004 may produce a collection of BMW cars for sale that roughly match the criteria of model year and mileage. The model years of cars in the collection may be from, say, 2003 to 2005. The mileage of cars in the collection may exhibit mileage in the range 30,000 to 40,000. Indeed, in some search engines, the user may expressly specify a range for model year, as well as a range for mileage. The simple keyword/range search does not, however, tell the user important facts that could be learned from the searchable data.

Accordingly, content analyzer 2010 will analyze the automobile data base to determine important facts that may be of interest to the user. This may be done in advance. For example, content analyzer 2010 may determine that a large cluster of 2002 BMW cars exhibit mileage in a range of 45,000 to 50,000. The system communicates this important fact to the user by displaying the listings of cars in the cluster. Thus, the search results comprise results that fall outside the scope of the original query. Note that the user has no a priori knowledge that 2002 BMW cars are clustered in the 45 k-50 k mileage range. Thus, the algorithm of content analyzer 2010 produces data in collections the user may not have thought of but would like to be informed of. The results so produced are based on the statistics and content of the data itself rather than strictly the keywords of the user.

As another example, suppose that a search is performed for restaurants in Austin. As mentioned, this may produce over 300 links. Content analyzer 2010 will analyze this data to determine trends. For example, content analyzer 2010 may determine that a large number of restaurants in Austin specialize in BBQ cuisine. Search processor 2002 may therefore send a collection of links to the user to restaurants in the database that serve BBQ. Moreover, content analyzer 2010 may determine that live music is played in many Austin restaurants and produce a collection of links to these restaurants. Content analyzer 2010 thus determines categories by analyzing the data.

Link organizer 2012 organizes the links into categories provided by content analyzer 2010. Link organizer 2012 will, for example, provide links with a category labeled “BBQ” and links with a category labeled “Live Music”. And/or, link organizer 2012 may provide links with a category labeled “BBQ and Live Music.” Server 2016 communicates the categories and the links to the user at his or her computer 2040. In one embodiment, the computer's video display may display the labels as links. When the user clicks on a label, the list of links under that label will be displayed.

FIG. 2 shows an embodiment of a processor 200 that can be implemented in a server such as server 116 to execute content-based search software as described herein. The processor 200 of FIG. 2 is configured to execute instructions of content-based search software to provide the functionality depicted in FIG. 2A and described with respect thereto. A level 1 instruction cache 210 receives instructions from memory 216 external to the processor, such as level 2 cache. Thus, content-based search software may be stored in memory as an application program. Groups of sequential instructions of the search software can be transferred to the L2 cache, and subgroups of these instructions can be transferred to the L1 cache.

An instruction fetcher 212 maintains a program counter and fetches search processing instructions from L1 instruction cache 210. The program counter of instruction fetcher 212 comprises an address of a next instruction to be executed. Instruction fetcher 212 also performs pre-fetch operations. Thus, instruction fetcher 212 communicates with a memory controller 214 to initiate a transfer of search processing instructions from a memory 216 to instruction cache 210. The place in the cache to where an instruction is transferred from system memory 216 is determined by an index obtained from the system memory address.

Sequences of instructions are transferred from system memory 216 to instruction cache 210 to implement search processing functions. For example, a sequence of instructions may instruct the processor to determine clusters about a first central data point. Another group of instructions may instruct the processor to determine clusters about a second central data point. Consider again, the search of BMW cars. The processor 200 may execute instructions to determine the location and content of clusters with respect to a mileage parameter. That is, the processor identifies a cluster of data about a mileage that is determined by the algorithm itself. In one embodiment, the algorithm determines a central data point (a mileage) that results in the densest population of BMW cars with similar mileages about the central data point that may be obtained. Processor 200 may also execute instructions to determine clusters of automobiles with respect to alternative makes and models within the same price range and model year. The processor therefore makes comparisons to determine if an item of data is in a cluster or outside the cluster. In one embodiment, an item of data is in the cluster if it falls within a radius of a central point. The center of a cluster is not known a priori but is determined by the algorithm implemented by processor 200.

Instruction fetcher 212 retrieves content-based search processing instructions passed to instruction cache 210 and passes them to an instruction decoder 220. Instruction decoder 220 receives and decodes the instructions fetched by instruction fetcher 212. Instruction buffer 230 receives the decoded instructions from instruction decoder 220. Instruction buffer 230 comprises memory locations for a plurality of instructions. Instruction buffer 230 may reorder the order of execution of instructions received from instruction decoder 220. Instruction buffer 230 therefore comprises an instruction queue to provide an order in which instructions are sent to a dispatch unit 240.

Dispatch unit 240 dispatches content-based search processing instructions received from instruction buffer 230 to execution units 250. In a superscalar architecture, execution units 250 may comprise load/store units, integer Arithmetic/Logic Units, floating point Arithmetic/Logic Units, and Graphical Logic Units, all operating in parallel. Dispatch unit 240 therefore dispatches instructions to some or all of the executions units to execute the instructions simultaneously. Execution units 250 comprise stages to perform steps in the execution of instructions received from dispatch unit 240. Data processed by execution units 250 are storable in and accessible from integer register files and floating point register files not shown. Thus, instructions are executed sequentially and in parallel.

FIG. 2 shows a first execution unit (XU1) 270 and a second execution unit (XU2) 280 of a processor with a plurality of execution units. Each stage of each of execution units 250 is capable of performing a step in the execution of a different content-based search processing instruction. In each cycle of operation of processor 200, execution of an instruction progresses to the next stage through the processor pipeline within execution units 250. Those skilled in the art will recognize that the stages of a processor “pipeline” may include other stages and circuitry not shown in FIG. 2.

Moreover, by multi-thread processing, multiple content-based search processes may run concurrently. For example, by executing instructions of different threads, the processor may conduct a numerical search contemporaneously with the conduct. of a natural language search. By multi-threading, more than one search may be performed at one time. Further, content analysis may be performed while a search is being performed. Thus, a plurality of instructions may be executed in sequence and in parallel to perform content-based search processing functions.

FIG. 2 also shows control circuitry 260 to perform a variety of functions that control the operation of processor 200. For example, an operation controller within control circuitry 260 interprets the OPCode contained in an instruction and directs the appropriate execution unit to perform the indicated operation. Also, control circuitry 260 may comprise a branch redirect unit to redirect instruction fetcher 212 when a branch is determined to have been mispredicted. Control circuitry 260 may further comprise a flush controller to flush instructions younger than a mispredicted branch instruction.

Branch instructions may arise from performing a plurality of content-based search processing functions. For example, determining if data falls within or without a cluster involves a branch instruction. If data falls within a cluster, then a sequence of instructions is followed to include the data as data in a category of data exhibiting a feature of the cluster determined by content analyzer 2010. If data does not fall within a cluster it is not included as data exhibiting a feature of the cluster. Hence, it will not be included in the data assigned to a category corresponding to the cluster. Other branch instructions arise in determining, during a natural language search, whether a word is a noun or a verb or an adjective. Determining if a word occurs with high frequency within the data of the keyword search results also involves a branch instruction. Control logic for executing these and other branch instructions is thus provided by control circuitry 260.

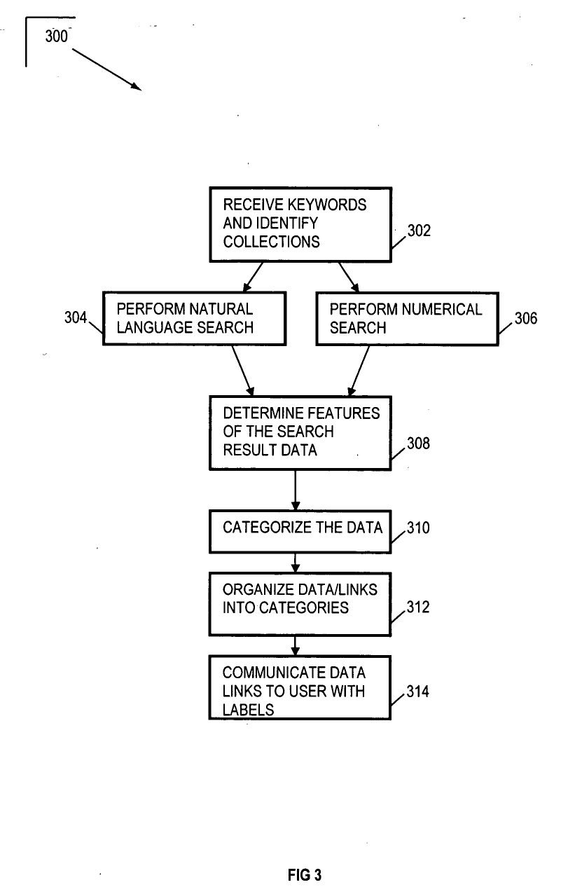

As mentioned, a data content-based search processor 2002 performs a plurality of processes concurrently. FIG. 3 shows a flow chart 300 of an embodiment of a processor 200 configured as a search processor 2002. The system receives keywords and identifies the collection of data associated with those keywords (element 302.) In a network environment with servers providing access to the internet, for example, a database of links associated with the key words is maintained. The links are to web pages that contain the keyword(s) or that are categorized under a keyword. Thus, the server may display a webpage with a list of keywords. Each keyword in the list is a link the user may click on with a mouse to select the link. Selecting the link may produce a set of links associated with the selected keyword of the link. Each link in the set of links is a link to a different web page that contains the keyword or that is classified there under.

In one embodiment, a processor within a server such as described above, receives computer instructions from a memory of the server. These instructions are executed by the processor in sequence and/or in parallel. Thus, to determine if a web page contains a keyword, the processor will make successive comparisons between the keyword and the contents of the webpage. This may be done word for word. The keyword search results are the web pages that contain the keyword. More particularly, the keyword search results may be stored as a set of links to the web pages that contain the keyword. The processor will further cause the links to be displayed on a user's video monitor when a user enters the keyword for a search.

The system performs a search of the content of the web pages to which the links correspond. The system may perform one or both of a natural language search (element 304) and a numerical search (element 306), which depends upon the nature of the data. For example, a search of restaurants in Austin will produce several hundred links. The system may perform a natural language search (element 304) of each web page to discover cuisine offered at each web page corresponding to the links. Thus, the system would process a web page by determining significant nouns, verbs, and adjectives, excluding words such as “the,” “an,” etc. and may also report a frequency of occurrence of each. The terms barbecue and seafood may occur with high frequency. As another example, a search of BMW cars will produce numerous links. The system may perform a numerical search (element 306) of the mileage of BMW cars to determine the mileages of cars offered for sale.

The system analyzes the results of the natural language search or numerical search to determine features of the data (element 308.) Features of the data are aspects of the data discovered from the analysis of the data itself. Features may include a change in derivative of the data, a clustering of the data, an occurrence of certain data with high frequency, a common trait exhibited by certain data, etc. For example, a content analysis may produce a set of links to cars with mileage that is unusually low for a given model, year, and make of car. Conversely, content analysis may result in exclusion of links to cars with unusually high mileage for a given model, year and make of car. The system may therefore determine a category entitled, “cars with relatively low mileage” (element 310). The system groups together the links falling in this category (element 312). The system communicates these links and the category title to the user (element 314). As another example, content analysis may determine that barbecue is a cuisine that is offered with relatively high frequency compared to seafood in Austin restaurants. The system may therefore determine a category entitled, “Barbecue” (element 310). The system groups together the links to restaurants that serve barbecue under this category title (element 312). The system communicates the links under each category heading to the user (element 314).

Some embodiments of the invention are implemented as a program product for use with a computer system such as, for example, the system 116 shown in FIG. 1. The program product could be used on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Thus, another embodiment of the invention provides a machine-accessible medium containing instructions effective, when executing in a data processing system, to cause the system to perform a series of operations for processing content-based searches. The series of operations generally include determining a collection of a data in the database according to keywords. The operations include performing a search upon the data in the collection to produce search result data, and analyzing the search result data to determine a feature of the search result data. The operations may further comprise performing a natural language search upon the data to determine words characterizing the data. Also, the operations may comprise determining a feature of the search result data by identifying data that exhibit a common trait. Further, the operations may comprise organizing data of the search result data according to categories determined by analyzing the search result data.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A search processor to process searches of data content of a database, comprising:
a search engine to search data content of the database to produce keyword search result data, the keyword search results identified according to keywords input by a user;
a content analyzer to analyze the data of the keyword search results to determine at least one category of the data from the analysis of the data;
a data organizer to organize the data according to the at least one categories determined from analysis of the data; and
displaying the categories determined from analysis of the data.

2. The search processor of claim 1, wherein the search engine comprises a natural language search mechanism to determine words characterizing content of the keyword search result data.

3. The search processor of claim 2, wherein the content analyzer analyzes the words determined by the natural language search mechanism to determine a feature of the keyword search data.

4. The search processor of claim 3, wherein the content analyzer comprises a cluster analyzer to determine data clusters within the keyword search data.

5. The search processor of claim 1, wherein the search engine comprises a numerical search mechanism to determine numerical data characterizing content of the database within the keyword search data.

6. The search processor of claim 5, wherein the content analyzer analyzes the numerical data determined by the numerical search mechanism to determine a feature of the keyword search data.

7. The search processor of claim 6, wherein the content analyzer comprises a cluster analyzer to determine data clusters within the keyword search data.

8. The search processor of claim 1, wherein the content analyzer comprises a cluster analyzer to determine data clusters within the keyword search data.

9. The search processor of claim 1, wherein the content analyzer is adapted to determine a feature of the keyword search data by identifying data with a similar trait.

10. The search processor of claim 1, further comprising a link organizer to organize links to data according to categories determined by the content analyzer.

11. A method for processing web searches, comprising:
providing a database comprising links to web pages categorized according to keywords; and
searching the database content according to keywords input by a user to determine links to web pages comprising the keywords;
searching the content of the web pages at the determined links to determine data content of the web pages;
analyzing the data content of the web pages to determine a category corresponding to a feature of the keyword search data; and
organizing the links according to the determined category.

12. The web search method of claim 11, wherein the content analysis is adapted to determine a feature of the keyword search data by identifying data with a similar trait.

13. The web search method of claim 12, wherein the content analysis is adapted to identify web page content with a similar trait by performing a cluster analysis of the data content.

14. The web search method of claim 11, wherein the search engine is adapted to perform a natural language search upon the web page content to determine words characterizing the data.

15. The web search method of claim 11, wherein the categories corresponding to the determined feature are determined by the content analysis of the data.

16. A machine-accessible medium containing instructions for processing searches of data base contents, which, when executed by a machine, cause said machine to perform operations, comprising:
determining a collection of data in the database according to keywords so that the keywords define data containing the keywords;
performing a search upon the data in the determined collection to produce search result data comprising data indicative of a feature of the data;
analyzing the search result data to determine a feature of the search result data; and
organizing the data according to a category corresponding to the determined feature.

17. The machine accessible medium of claim 14, wherein performing a search upon the data of the collection comprises performing a natural language search upon the data in the collection to determine words characterizing the data.

18. The machine accessible medium of claim 15, wherein determining a feature of the data further comprises identifying data that exhibit a common trait.

19. The machine accessible medium of claim 14, wherein analyzing the search result data comprises performing a cluster analysis upon the search result data.

20. The machine accessible medium of claim 17, wherein organizing the data comprises organizing the search result data according to categories determined by analyzing the search result data.
